(19) United States
(12) Patent Application Publication
(10) Pub. No.: US 2019/0206417 A1
(43) Pub. Date: Jul. 4, 2019

(54) CONTENT-BASED AUDIO STREAM SEPARATION

(71) Applicant: Knowles Electronics, LLC, Itasca, IL (US)

(72) Inventors: John Woodruff, Mountain View, CA (US); Mathieu Parvaix, Mountain View, CA (US); Pratik Shah, Mountain View, CA (US)

(73) Assignee: Knowles Electronics, LLC, Itasca, IL (US)

(21) Appl. No.: 16/234,146

(22) Filed: Dec. 27, 2018

Related U.S. Application Data
(60) Provisional application No. 62/611,218, filed on Dec. 28, 2017.

(51) Int. Cl. G10L 21/028; H04R 1/40; H04R 3/00; G10L 25/51

(52) U.S. Cl. CPC G10L 21/028; G10L 25/51; H04R 3/005; H04R 1/406

(57) ABSTRACT

A method for separating audio signals based on categories is disclosed herein. The method includes receiving an audio signal; generating a plurality of filters based on the audio signal, each of the filters corresponding to one of a plurality of sound content categories; and separating the audio signal into a plurality of content-based audio signals by applying the filters to the audio signal, each of the content-based audio signals contains a content of a corresponding sound content category among the plurality of sound content categories.

### CROSS-REFERENCE TO RELATED APPLICATIONS

The present application claims priority to U.S. Provisional Patent Application No. 62/611,218 filed Dec. 28, 2017, the contents of which are incorporated by reference herein in their entirety.

### TECHNICAL FIELD

This application relates generally to audio processing and more particularly to content-based audio stream separation.

### BACKGROUND

There is considerable market interest in technology that can analyze captured audio signals (e.g., from a microphone array) and enhance (or separate) one or more of the source signals. Existing systems typically approach this problem in one of two ways. Some systems assume there is a single “target” signal in the presence of background noise (a scenario referred to as target-in-noise paradigm). For example, this approach has been used for speech enhancement, noise suppression and beamforming systems. Alternatively, some systems attempt to perform blind source separation (BSS), whereby all sound sources in the environment are separated from one another such that multiple output signals, one for each sound source, are produced.

The target-in-noise paradigm is useful in some applications, but not as useful in other areas such as virtual reality (VR), augmented reality (AR), video chat and other connected devices. In such applications, if all sources could be effectively separated after being captured by a microphone array, it would be possible to adjust the level, quality and spatial position of each source, similar to the way that sound engineers mix independently recorded tracks in audio production. However, existing BSS approaches are impractical because they make unrealistic assumptions, such as knowledge of the number of sound sources, sound-source directions, and/or that the sources and device do not move too quickly. Unrealistic assumptions cause inaccuracy in separation of signals of the sound sources and prevent deployment of BSS technology in real-world applications.

### BRIEF DESCRIPTION OF THE DRAWINGS

For a more complete understanding of the disclosure, reference should be made to the following detailed description and accompanying drawings wherein:

FIG. 1 illustrates examples of sound sources corresponding to various sound content categories, according to an exemplary embodiment;

FIG. 2 illustrates a flow chart of an example method of separating audio signals based on categories, according to an exemplary embodiment;

FIG. 3 illustrates a flow chart of an example method of training a neural network for separating audio signals based on categories, according to an exemplary embodiment;

FIG. 4 is a block diagram illustrating example training and filtering processes of a deep neural network of an audio separation system, according to an exemplary embodiment;

FIG. 5 illustrates a flow chart of an example method of separating audio signals based on categories using a trained neural network, according to an exemplary embodiment;

FIG. 6 is a block diagram illustrating components of an audio separation system, according to an exemplary embodiment;

FIG. 7 is a block diagram illustrating an audio processing system of an audio separation system, according to an exemplary embodiment.

### DETAILED DESCRIPTION

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

According to certain general aspects, the present embodiments are directed to an audio separation technology that is capable of separating an audio signal captured by one or more acoustic sensors into one or more sound signals of specific sound categories. In some embodiments, the disclosed audio separation technology utilizes deep learning to separate the sound signals (also referred to as audio signals or audio streams if continuously fed) based on specific sound content categories (also referred to as content classes) such as speech, music or ambient sound.

In some particularly useful embodiments, the disclosed audio separation technology may be used to separate out speech from an individual talker or persons in a conversation from other sounds present in an audio signal that contains the conversation. As such, the present embodiments can be used to improve speech quality in various speech-centric applications such as hearing aids, cellular phone or other communication systems and voice interface systems (e.g. voice controlled remote controls), or enable talker separation in voice conference systems. In some other embodiments, the disclosed audio separation technology may be used to separate non-speech sounds, separate different sound content, and even recognize underlying content classes.

To illustrate certain aspects of some embodiments, consider a scenario where a captured audio signal contains a conversation of two people talking near a jazz trio at an outdoor cafe. BSS attempts to separate all sources, including both talkers, each instrument of the jazz trio and any prominent ambient sound sources nearby. But BSS makes impractical assumptions and fails in such complex acoustic scenes. By contrast, the disclosed technology is capable of separating the speech content (e.g., from both talkers) from the music content (e.g., from the entire jazz trio) and from other ambient sounds. The disclosed technology enables capabilities analogous to film production, where sound engineers can combine dialogue, music and ambient tracks to achieve a final audio mix for a film. Further, because the disclosed technology utilizes deep learning rather than beamforming or BSS, the disclosed technology is capable of preserving spatial information captured by a microphone array (or other acoustic sensor(s) capturing the sound signals). The spatial information can be used to, e.g., reproduce the captured sound environment for VR or AR applications.

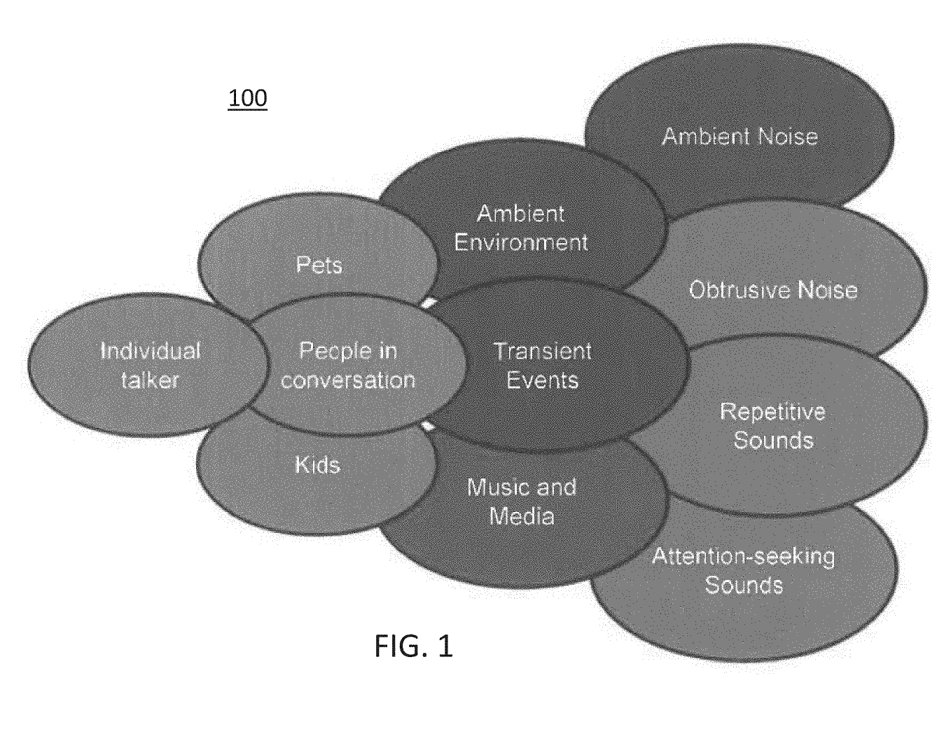

To further illustrate certain aspects of the present embodiments, FIG. 1 provides examples of possible sound content categories that can exist in an environment 100 (also referred to as sound environment or sound stage) in which the disclosed audio separation can be applied, for example a home environment. As shown, the environment 100 may include at least one individual talker who is speaking. The environment 100 may include other humans or animals making sounds, such as other people in conversation, kids playing, laughing or crying, or pets making sounds. In addition, the environment 100 may include music and/or sound media (e.g., sound track of a film), transient event sounds (e.g., sounds from humans in the environment handling metal objects or aluminum cans, chopping food, dropping a plate or glass, etc.), and/or ambient environment sounds. As shown, the ambient environment sounds can include sounds which can be further broken down into different specific categories such as ambient or background noise (e.g., machine buzzing or humming, air conditioner sound, washing machine swirling, etc.), repetitive sounds (e.g., hammering, construction sound, ball bouncing, etc.), obtrusive noise (e.g., vacuum, coffee grinder, food processor, garbage disposal, drill, etc.), or attention-seeking sounds (e.g., ringers, horns, alarms, sirens, etc.). It should be apparent that many of these categories including the ambient environment sound categories can be further broken down or consolidated in various ways.

The present applicant recognizes that the problem of separating out sounds for various categories such as those described above is especially challenging because there can be substantial temporal and spectral overlap between the sounds. Prior art approaches such as BSS cannot effectively distinguish between sounds under these conditions. In view of these and other challenges, according to some embodiments of the present disclosure to be described in more detail below, the disclosed audio separation technology utilizes deep learning to separate sound signals based on content categories. Deep learning refers to a learning architecture that uses one or more deep neural networks (NNs), each of which contains more than one hidden layer. The deep neural networks may be, e.g., feed-forward neural networks, recurrent neural networks, convolutional neural networks, etc. In some embodiments, data driven models or supervised machine learning models other than neural networks may be used for audio separation as well. For example, a Gaussian mixture model, hidden Markov model, or support vector machine may be used in some embodiments.

In particular, in some embodiments, the disclosed audio separation technology uses deep neural networks to estimate filters (i.e. time-frequency masks) for filtering the sound signal(s). A time-frequency mask is a real-valued or complex-valued function (also referred to as masking function) of frequency for each time frame, where each frequency bin has a value between 0 and 1. The masking function is multiplied by a complex, frequency-domain representation of an audio signal to attenuate a portion of the audio signal at those time-frequency points where the value of the masking function is less than 1. For example, a value of zero of the masking function mutes a portion of the audio signal at a corresponding time-frequency point. In other words, sound in any time-frequency point where the masking function is equal to 0 is inaudible in a reconstructed output signal filtered by the masking function.

In some embodiments, the disclosed audio separation technology transforms at least one time-domain audio signal captured from one or more acoustic sensors (e.g., microphones) into a frequency domain or a time-frequency domain (using, e.g., fast Fourier transform (FFT), short-time Fourier transform (STFT), an auditory filterbank and/or other types of suitable transforms). The disclosed audio separation technology performs feature extraction on the frequency domain representation of the audio signal. The extracted signal features are used as inputs to at least one deep neural network. The neural network may run in a real time as the audio signal is captured and received. The neural network receives a new set of features for each new time frame and generates one or more filters (i.e. time-frequency masks) for that time frame. Each filter corresponds to a pre-defined sound content category. The frequency-domain audio signal(s) are multiplied by the masking functions of the filters and resynthesized into the time domain to produce multiple output signals. Each output signal is an audio signal of a corresponding audio content category.

Although embodiments of the disclosed audio separation technology may find useful application in performing speech separation, the disclosed technology can be applied to sound sources including or excluding human speech, because of its inherent ability to recognize different content categories. At least one type of output of a disclosed audio separation system can be multiple channels of audio streams for different content categories, as well as metadata (e.g., spatial information of sound sources) for each channel.

In embodiments, an offline training stage is used to train the deep neural network to recognize the differences between different sound classes in the feature space defined by the features that are extracted from the audio signals. The training process may involve feeding a training data set including audio signals with known sound content categories. The known sound content categories may include, e.g., one or more of the categories illustrated in FIG. 1. During the training process, parameters of the deep neural network are adjusted so that the deep neural network is optimized to generate separated audio signals that are the same as, or close to, the original separate audio signals of different known sound content categories. Thus, the trained deep neural network can predict filters that preserve the specific sound content category of interest while suppressing audio energy of other sound content categories.

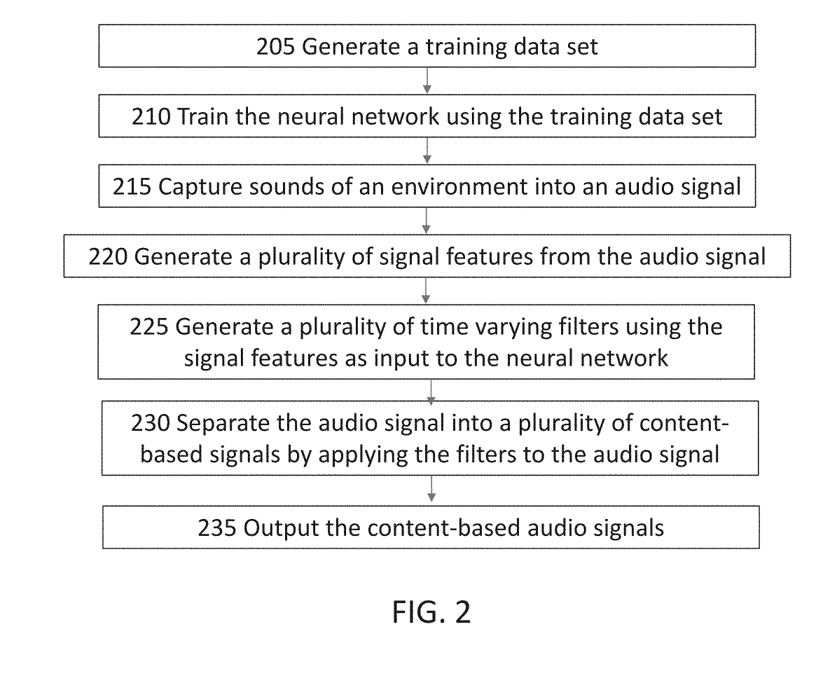

FIG. 2 illustrates a flow chart of an example method of separating audio signals based on categories according to the present embodiments. At step 205, a training data set is generated, for example by combining a first audio signal of a first known sound content category and a second audio signal of a second known sound content category into a training audio signal. The training data set is used to train a neural network of the audio separation system. It should be apparent that there can be more than two audio signals and corresponding known sound content categories used for training, depending on the number of sound content categories that are required in a particular application.

At step 210, the system trains the neural network by feeding the training audio signal into the neural network and optimizing parameters of the neural network. The goal of the training of the neural network is that a trained version of the neural network can be used to separate the training audio signal (in this simplified example) into an instance of the first audio signal and an instance of the second audio signal. Those instances are the same as, or close to, the original first and second audio signals. Once the neural network is trained, the audio separation system can perform audio separation. It should be noted that, although shown here along with other processing for ease of illustration, step 210 can actually be performed in an off-line process that is separate from the remaining “on-line” processing performed as described below.

Having the trained neural network, at step 215, one or more microphones (e.g., a microphone array) capture sounds of an environment into an audio signal. The audio signal includes a combination of content-based audio signals. In some embodiments, the one or more microphones are part of the audio separation system. In some other embodiments, the one or more microphones are external components or devices separate from the audio separation system.

At step 220, a feature extraction module of the audio separation system generates a plurality of features from the audio signal. Examples of features that can be extracted from the audio signal, as well as examples of how feature extraction can be done, are described in more detail below.

At step 225, the neural network of the audio separation system generates a plurality of time-varying filters in a frequency domain using the signal features as inputs to the neural network. Each of the time-varying filters corresponds to one of a plurality of sound content categories. In some embodiments, each of the time-varying filters is a time-varying real-valued or complex-valued function of frequency. A value of the real-valued or complex-valued function for a corresponding frequency represents a level of attenuation for the corresponding frequency.

At step 230, the audio separation system separates the audio signal into a plurality of content-based (i.e., category specific) audio signals by applying the time-varying filters to the audio signal. Each of the content-based (i.e., category specific) audio signals contains content of a corresponding sound content category among the plurality of sound content categories for which the system has been trained. In some embodiments, the content-based audio signals are produced by multiplying the audio signal by the time-varying real-valued or complex-valued functions.

At step 235, the audio separation system outputs the content-based audio signals, possibly along with spatial information of sound sources that emit sounds of the sound content categories, as will be described in more detail below. In some embodiments, a sound of particular interest contained in the audio signal (for example, speech) may be enhanced by attenuating sound levels of some of the content-based audio signals corresponding to other sound content categories of the plurality of sound content categories.

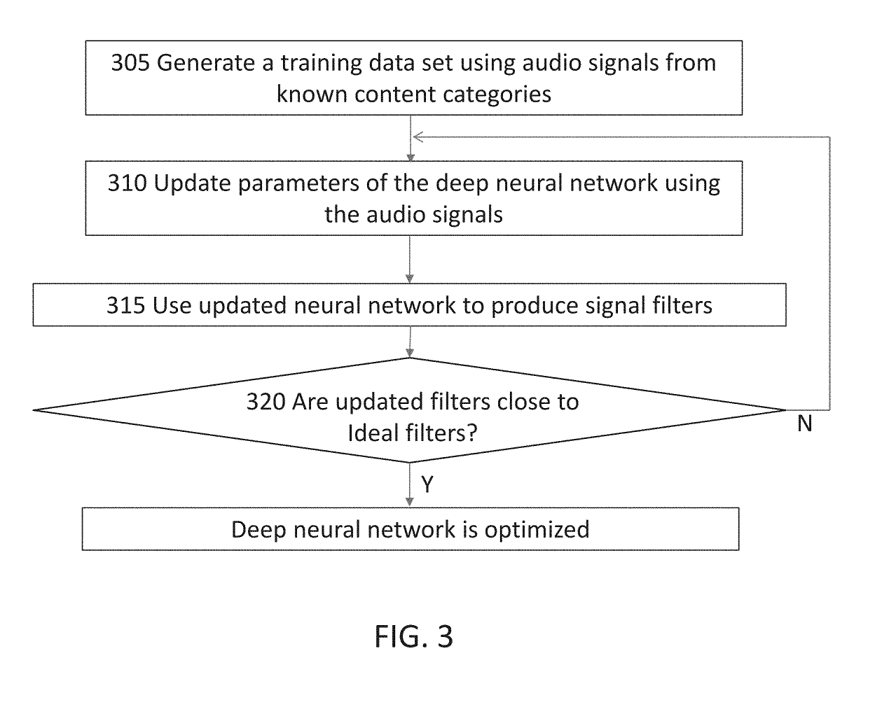

FIG. 3 is a flowchart further illustrating an example method of training a deep neural network of an audio separation system, according to some embodiments of the present disclosure. As set forth above, the training process starts in step 305 by generating a training data set including audio signals with known content categories. For example, speech, music and transient event sound content could be drawn from a large audio database. Audio content in this database is preferably captured with one (mono) or two (stereo) high-quality microphones at close range in a controlled recording environment. The audio signals in this database are preferably tagged with known content categories or descriptive attributes, e.g., “dog barking” or “dishwasher sound”. Each audio content signal drawn from the database is convolved with a multi-microphone room impulse response (RIR) that characterizes acoustic propagation from a sound source position to the device microphones. After convolution with device RIRs, the multi-microphone audio signals for each content category, known as the “clean” signals, are mixed at different signal levels to create a multi-microphone audio mixture. In order for the pre-trained model to generalize to unseen acoustic data, it is important to generate a multitude of audio mixtures with many instances of sound events corresponding to each content category, e g many speech utterances, music recordings and different transient events, etc. Further, it is desirable to use RIRs for many sound source positions, device positions and acoustic environments and to mix content categories at different sound levels. In some embodiments, this process may result in tens, hundreds or even thousands of hours of audio data.

In step 310, a model coefficient update process is performed to update parameters of the deep neural network until the deep neural network is optimized to make predictions consistent with the known content categories. As shown in this example, the update process can be performed iteratively from random coefficient initialization and in step 315 the updated deep neural network is used to produce separated audio signals. For example, and as will be described in more detail below, the training data containing signals with the known sound categories can be fed to a feature extraction module to generate features in the frequency domain. The deep neural network that is being trained receives the signal features and generates a set of frequency masks that filter the audio signals to generate separated audio signals corresponding to the known sound content categories, which may include the known target signal and the known interference signal.

In step 320 the filters (i.e. frequency masks) that are generated by the deep neural network to separate content streams are compared to the optimal filters, or “labels”. Optimal filters are available in training because audio mixtures are created from mixing the clean content signals, making it possible to compute the filter that perfectly reconstructs the magnitude spectrum of the desired signal for a given content category in a process called label extraction. As shown, the model coefficient update process in step 310 can be repeated iteratively, for example using a gradient descent approach, until the filters produced by the deep neural network are very close to the optimal filters, at which point the deep neural network is optimized. In some embodiments, rather than, or in addition to, comparing the generated filters to optimal filters, the magnitude spectra or complex spectra of the separated content signals can be estimated directly by the deep neural networks. In this case, the spectra produced by the deep neural network can be compared to the clean signal spectra during optimization.

It should be noted that the training process performed as illustrated in the example method described in connection with FIG. 3 is an offline process. Offline training of the deep neural network must be performed for an initial audio separation configuration. However, in some embodiments, the deep neural network coefficients can be updated online to further optimize performance for the acoustics and environment of a given device. In this case the network is not able to learn new content categories, but is able complement the initial training data with new data collected live on the device. Because updating the neural network coefficients requires definition of the optimal filter (i.e. frequency mask), or equivalently the clean signal spectra, any newly collected data live on device must largely contain only one content category. Time segments of live audio that contain only one of the pre-defined content categories can be found by comparing the estimated content signals to the input audio mixture. When an estimated content signal is very close to the audio mixture, it can be assumed that no other audio content is present. This data can be captured and added to the content used during model training. Model coefficients could then be updated and then downloaded to update the coefficients being used by the online system. This process would not be expected to occur in real-time and training may not be performed directly on device. However, this approach enables the networks to refine themselves over a period of minutes, hours or even days through occasional model updates.

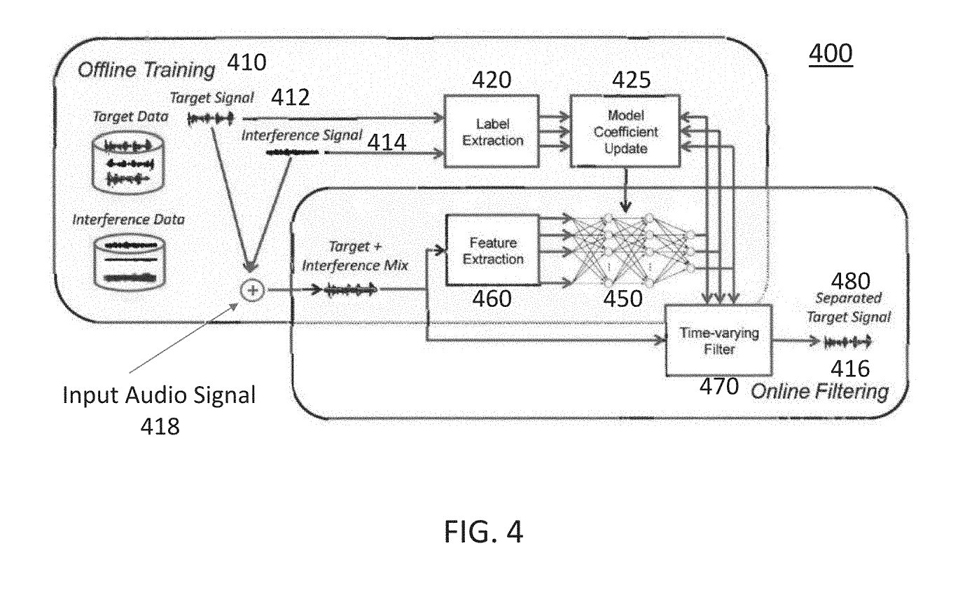

For example, FIG. 4 is a block diagram illustrating one possible way of combining offline training and online filtering processes of a deep neural network of an audio separation system, according to some embodiments of the present disclosure. In such embodiments, an offline training stage 410 is used to train the deep neural network 450 as described above. More particularly, the offline training stage 410 involves feeding a training data set including audio signals with known content categories. For example, an audio signal of the training data set may be various combinations of a target signal 412 of a known sound content category (e.g., speech) and one or more interference signals 414 of another known sound content category (e.g., music, ambient sound or noise, etc.).

The combination of the target signal 412 and the interference signal 414 is used to perform a label extraction 420 to obtain the optimal filter for each of the sound content categories of the signals. More particularly, because the “clean” version of the target signal 412 is known, it is very straightforward to compute the optimal filter that can be applied to the combination of the target signal 412 and the interference signal 414 so as to obtain the target signal 412. During the offline training, a model coefficient update process 425 is performed using features extracted from the combination of the target signal 412 and interference signal 414 to update parameters of the deep neural network 450 until the deep neural network 450 is optimized to make predictions consistent with the known content categories. In other words, the optimized deep neural network 450 can be used to produce separated audio signals that are the same as, or close to, the target signal 412 and the one or more interference signals 414 of known sound content categories.

Once the deep neural network 450 is trained, the deep neural network 450 may be downloaded to operate in an online filtering stage 416. As will be described in more detail below, an audio input 418 containing audio signals of various sound categories can be fed to a feature extraction module 460 to generate signal features in the frequency domain (the same signal features that are extracted during off-line training). The deep neural network 450 (trained during the offline process described above) receives the signal features and generates a set of time-varying filters 470 (i.e. frequency masks). The time-varying filters 470 filter the audio signals to generate separated audio signals 480 of various sound content categories, which may include the target signal (e.g., an audio signal of a target sound content category such as speech).

As further shown in FIG. 4, during the online filtering process 416, the filtering results can be fed back into model coefficient update process 425 and used to update the model coefficients used by deep neural network 450. For example, time segments of live audio 418 that contain only one of the pre-defined content categories can be identified in various ways, and these time segments can be used to refine the model coefficients so as to more closely align the deep neural network 450 for the particular online device and/or environment. In a passive approach example, the time segments are identified by comparing the estimated content signals 480 to the input audio mixture 418. When a time segment of an estimated content signal 480 for one of the pre-defined content categories is very close to the input audio mixture 418 (e.g., when there is a confidence of 95% or more that the audio mixture 418 contains only sound of one of the pre-defined content categories), it can be assumed that no other audio content is present in that time segment. In other embodiments, a confidence score can be computed based on the computed filters rather than based on the output content. In an active approach example, the time segments are purposely identified, for example by a device user. More particularly, the device user can indicate that an input audio mixture 418 captured by the device during a given time segment only contains sound of a specific sound category (e.g. background noise such as a television playing in the background). This indication can occur either after the time segment has elapsed, or in advance of a time segment (e.g. the user makes the indication, and then uses the device to capture the sound).

These captured time segments of live audio data can then be uploaded back to the offline model training 410 process and added to the content used during offline model training 410. Model coefficients could then be updated in stage 425 of offline training process 410 and then the updated deep neural network 450 can be downloaded back to the online filtering stage 416 to update the coefficients being used by the network 450 of the online system 416. In other embodiments, the deep neural network 450 can be incrementally updated online on the device itself using the captured time segments of live audio data.

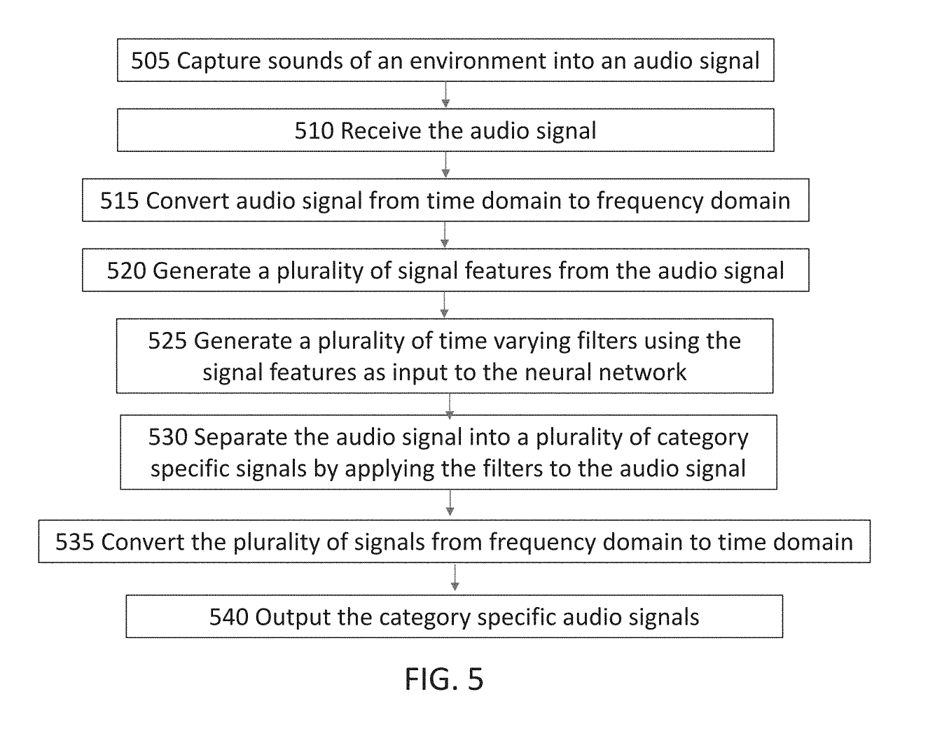

Returning to FIG. 2, an example process of separating audio signals based on categories such as described in connection with steps 220 to 235 will now be described in more detail, with reference to the flowchart in FIG. 5. In embodiments, this method can be performed using a deep neural network that has been trained as described above.

At step 505, one or more microphones (e.g., a microphone array) capture sounds of an environment into an audio signal. The audio signal includes a combination of content-based audio signals. In some embodiments, the one or more microphones are part of the audio separation system. In some other embodiments, the one or more microphones are external components or devices separate from the audio separation system.

At step 510, the system receives the audio signal. At step 515, the system converts the audio signal from a time domain to a frequency domain. At step 520, a feature extraction module of the audio separation system generates a plurality of signal features from the audio signal. The particular set of signal features that are extracted in this step 520 should be the same set of signal features that are/were used during training of the neural network. The signal features can be extracted from the audio signal in various ways known to those skilled in the art, depending upon the type of signal feature that is extracted. For example, where the audio signal comprises sounds captured by several different microphones, the signal features can include phase differences between sound signals captured by the different microphones, magnitude differences between sound signals captured by the different microphones, respective microphone energies, etc. For individual sound signals from a given microphone, the signal features may include magnitude across a particular spectrum, modulations across a spectrum, frames of magnitude spectra, etc. In these and other embodiments, the signal features may include information representing relationships or correlations between the audio signals of various sound content categories and/or between audio signals from different microphones such as inter-microphone coherence. In some embodiments, the signal features may be represented by, e.g., vectors. In additional or alternative embodiments, some or all of signal features can also be extracted captured from the time-domain signals (i.e. some portions of step 520 can be performed before step 510).

At step 525, the neural network of the audio separation system generates a plurality of time-varying filters in a frequency domain using the signal features as inputs of the neural network. Each of the time-varying filters corresponds to one of a plurality of sound content categories. In some embodiments, each of the time-varying filters is a time-varying real-valued function of frequency. A value of the real-valued function for a corresponding frequency represents a level of attenuation for the corresponding frequency or range of frequencies. For example, a value of 0.5 for a given frequency or frequency range would cause the signal amplitude for that frequency or frequency range to be reduced by half.

At step 530, the audio separation system separates the audio signal into a plurality of category specific audio signals by applying the time-varying filters to the audio signal. Each of the category specific audio signals contains content of a corresponding sound content category among the plurality of sound content categories. In some embodiments, the category specific audio signals are produced by multiplying the audio signal by the time-varying real-valued functions.

At step 535, the system converts the category specific audio signals from the frequency domain into the time domain. At step 540, the audio separation system outputs the category specific audio signals, possibly along with spatial information of sound sources that emit sounds of the sound content categories as will be described in more detail below.

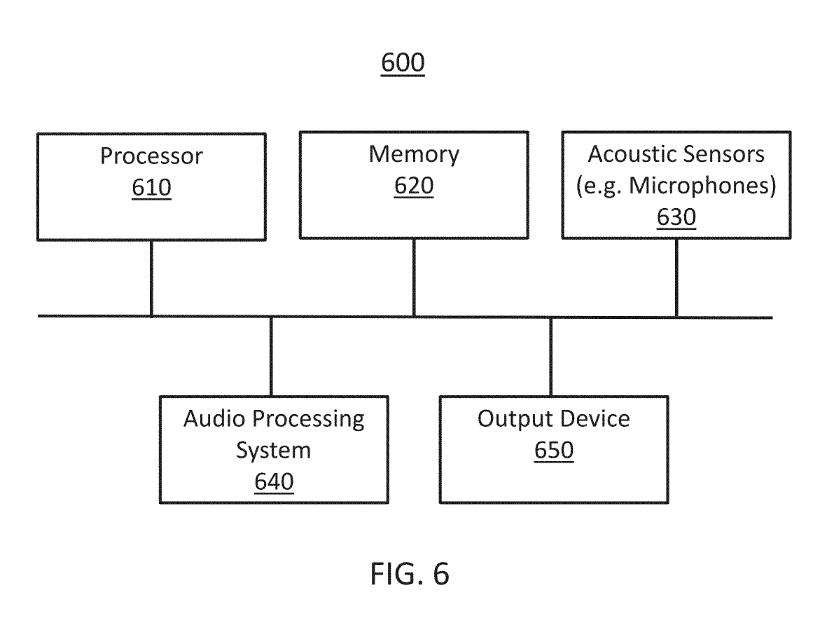

FIG. 6 is a block diagram illustrating components of an example audio separation system 600, according to some embodiments of the present disclosure. As illustrated in FIG. 6, the audio separation system 600 may include a processor 610, a memory 620, one or more acoustic sensors 630, an audio processing system 640, and an output device 650. In some other embodiments, the system 600 may include more or other components to provide a particular operation or functionality. Similarly, in some other embodiments, the system 600 includes fewer components that perform similar or equivalent functions to those depicted in FIG. 6.

The processor 610 may include hardware and software that implement the processing of audio data and various other operations depending on a type of the system 600. For example, at least some components of the system 600 may be a part of a communication device (e.g., a mobile phone) or a computing device (e.g., a computer). Memory 620 (for example, non-transitory computer readable storage medium) stores, at least in part, instructions and data for execution by processor 610 and/or the audio processing system 640.

The audio processing system 640 may be configured to receive acoustic signals representing at least one sound captured by the one or more acoustic sensors 630 and process the acoustic signal components such as performing audio separation based on content categories. The acoustic sensors 630 may be, e.g., microphones. Although various examples are described in regard to the acoustic sensor(s) 630 being one or more microphones 630, other suitable acoustic sensors may be used. In some embodiments, an array of two or more acoustic sensors (e.g., microphones) 630 are spaced at a spatial pattern such that the acoustic waves impinging on the device from certain directions and at different phases exhibit different energy levels at the array of two or more acoustic sensors. After reception by the acoustic sensors (e.g., a microphone array) 630, the acoustic signals can be converted into electric signals. These electric signals can, in turn, be converted by an analog-to-digital converter into digital signals for processing in accordance with some embodiments described herein. In some embodiments, the electric signals from the acoustic sensors 630 are digital signals. In still further embodiments, the microphones may be placed in different locations pointing to different directions in an environment.

The output device 660 is a device that provides audio output (e.g. one or more separated sound signals) to an external device. For example, the output device 660 may include a network interface or other data communications interface. In some embodiments, the audio output may be stored in memory 620 before being provided to an external device.

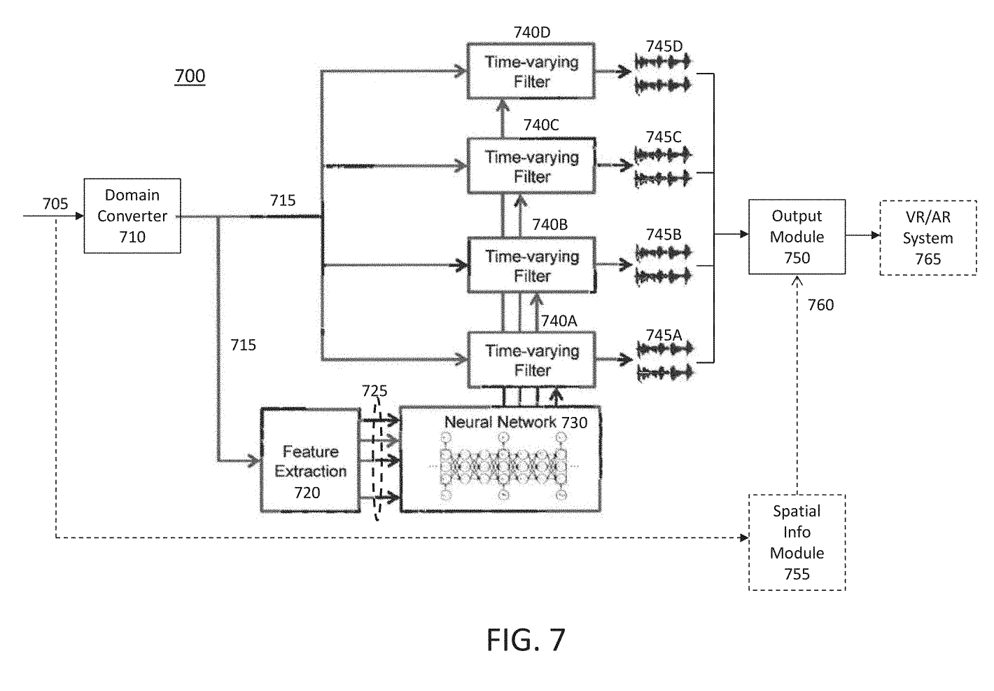

FIG. 7 is a block diagram illustrating an audio processing system of an audio separation system, which can be used to implement part or all of audio processing system 640 according to some embodiments of the present disclosure. The audio processing system 700 in these embodiments includes a domain converter 710, a feature extraction module 720, a neural network 730, one or more time-frequency masks 740A-740D, and an output module 750.

Notably, in embodiments, neural network 730 is a deep neural network that has been trained for specific sound categories, for example using the methodologies described above in connection with FIGS. 3 and 4.

In some embodiments, the domain converter 710 receives at least one input audio signal 705 presented in the time domain. The input audio signal 705 includes a combination of sound signals of different content categories. For example, the input audio signal 705 may include a combination of speech, music, and/or ambient sound. In some other embodiments, the input may include multiple audio signals. For example, the input may include multiple audio signals captured by the microphones of the array.

In some embodiments, the input audio signal 705 is comprised of, or is converted into, frames containing audio for a certain amount of time. In these and other embodiments, for each time frame, the domain converter 710 converts the input audio signal 705 from the time domain to a frequency domain. In some embodiments, the conversion may be performed using, e.g., an auditory filterbank, FFT, or STFT. Each time frame of the converted audio signal 715 presented in the frequency domain is fed to the feature extraction module 720. The domain converter 710 may continuously process the input audio signal 705 for each time frame and continuously feeds the converted signal 715 for each time frame to the feature extraction module 720.

In the illustrated embodiment, the feature extraction module 720 extracts signal features 725 in the frequency domain representation of signal 715. The feature extraction module 720 further feeds the signal features 725 to the neural network 730. The signal features 725 may include information such as that described above in connection with FIG. 5. In additional or alternative embodiments, some or all of signal features 725 can also be captured from the time-domain signals.

In some embodiments, for each time frame, the neural network 730 receives a new set of signal features 725 as input and may run in real time as the audio processing system 700 continuously receives the input audio signal 705. In real time, using the set of signal features 725 as input, the neural network 730 generates a set of filters 740A, 740B, 740C, and 740D for the specific time frame. Each time-varying filter 740A, 740B, 740C, 740D corresponds to a pre-defined sound content category. As should be apparent, the filters of the sound content categories can be different from each other, and so each sound content category at a specific time frame has its own unique filter. The term “time-varying filter” refers to the fact that a filter for a given one of the sound categories for a first time frame may be different than the filter for the given sound category in a second time frame based on changing signal features 725 over time.

The domain converter 710 sends the converted audio signal 715 in the frequency domain for a specific time frame to the filters 740A-740D generated for the same specific time frame. Each of the filters 740A-740D filters the converted audio signal 715 into a separated audio signal 745A, 745B, 745C, or 740D. Each of the separated audio signals 745A, 745B, 745C, or 740D includes an audio signal of a corresponding sound content category.

More particularly, in some embodiments, each of the filters 740A-740D is a real-valued (or alternatively, complex-valued) function (also referred to as masking function) of frequency for a specific time frame, where each frequency bin (e.g., a frequency range) has a value from 0 to 1. Thus, each of the filters 740A-740D filters the converted audio signal 715 in the frequency domain by multiplying the converted audio signal 715 by the masking function. A portion of the audio signal is attenuated at frequency points where the value of the masking function is less than 1. For example, a value of zero of the masking function mutes a portion of the audio signal at a corresponding frequency point. In other words, sound in frequency points where the masking function is equal to 0 is inaudible in a reconstructed output signal filtered by the masking function.

In some other embodiments, for example, the input audio signal 705 may include multiple audio signals. For example, the input may include multiple audio signals captured by the microphones of the array. In some embodiments, the input audio signal 705 comprising the multiple separate audio signals are combined together for use in generating the filters 740A-740D. After the filters are generated for a given time frame, they are used to filter each of the multiple input audio signals in the input audio signal 705 individually, which results in multiple separated audio signals 745A, 745B, 745C and 745D, one for each audio input for each time frame. This may help preserve the spatial information of the source sources, which can be derived from information about the respective positions of the microphones of the array as described in more detail below, for example.

In some embodiments, the output module 750 receives the separated audio signals 745A, 745B, 745C, and 745D for the corresponding sound content categories and may convert the separated audio signals 745A, 745B, 745C, and 745D from the frequency domain back to the time domain In some embodiments, the output module 750 may output the separated audio signals 745A, 745B, 745C, and 745D to other systems or modules for further processing depending on the applications. In some embodiments, prior to signal outputting, the output module 750 may combine the separated audio signals 745A, 745B, 745C, and 745D into one or more combined audio signals. For example, each combined audio signal may include one or more channels, each channel corresponding to a different sound content category. In some embodiments, the number of separated audio signals (and the number of masks) may vary according to various embodiments.

The audio signals separated based on sound content categories (either as separate audio signal streams or channels of an audio signal stream) may be used for various applications such as reproducing a sound environment in virtual reality (VR) or augmented reality (AR) applications. For example, as shown in FIG. 7, output module 750 may output the separated audio signals to a VR reproduction system including a VR audio rendering system 765. The VR reproduction system in this example is external to the audio separation system 700. In other embodiments, the VR reproduction system may be included in a same system with the audio processing system 700, in which case output module 750 may not be needed.

In these and other embodiments, the output module 750 may output the separated audio signals 745A, 745B, 745C, and 745D along with metadata 760. In such embodiments, metadata 760 includes spatial information of sound sources that is generated by spatial information module 755. For example, the input audio signal 705 may include multiple audio signals captured by multiple microphones of an array. Spatial information module 760 has access to information about the relative physical locations of these microphones and uses this information and the relative strength of the separated audio signal from each of the input audio signals to estimate a spatial location of a sound source for the corresponding sound category.

The VR audio rendering system 765 receives the separated audio signals 745A, 745B, 745C, and 745D and the metadata 760 (e.g., spatial information of sound sources) and performs further audio processing for VR rendering. For example, the VR audio rendering system 765 may mix and/or playback one or more of the separated audio signals 745A, 745B, 745C, and 745D based on the spatial information of sound sources, such that the VR audio rendering system 765 recreates a sound environment (also referred to as sound stage) that is the same as, or similar to, the actual sound environment including the original sound sources. For example, the VR audio rendering system 765 may be included in an overall virtual reality system that displays both video and audio. In an example where one of the audio signals 745 is associated with human speech, the overall system may display an avatar or animated person in a virtual environment or virtual world, and the audio signal 745 may be rendered so as to originate from the mouth of the avatar or animated person, with the display including the mouth moving in accordance with the rendered audio. If another of the audio signals 745 is associated with music, for example, the video and audio display may further include a band, with the sound originating from the band. Using the spatial information of the sound source of 745 (e.g. a person speaking), AR audio rendering system 765 may further dynamically adjust the mixing and playback of the audio signals, for example depending on a position and an orientation of a head of the user wearing a VR headset.

It should be noted that the term “rendering” of the separated audio signals 745 should be construed broadly to include many different types of applications that may or may not include VR or AR applications, such as selectively filtering out unwanted noises. For example, one of the audio signals 745 can be associated with a speech content category and another of the audio signals 745 can be associated with a background noise content category, and the rendering system 765 can allow a user to dynamically select whether or not to mute the audio signal 745 associated with the background noise content category.

As used herein, the singular terms “a,” “an,” and “the” may include plural references unless the context clearly dictates otherwise. Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific embodiments thereof, these descriptions and illustrations do not limit the present disclosure. It should be understood by those skilled in the art that various changes may be made and equivalents may be substituted without departing from the true spirit and scope of the present disclosure as defined by the appended claims. The illustrations may not be necessarily drawn to scale. There may be distinctions between the artistic renditions in the present disclosure and the actual apparatus due to manufacturing processes and tolerances. There may be other embodiments of the present disclosure which are not specifically illustrated. The specification and drawings are to be regarded as illustrative rather than restrictive. Modifications may be made to adapt a particular situation, material, composition of matter, method, or process to the objective, spirit and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. A method for separating an audio signal into a plurality of category specific audio signals respectively corresponding to a plurality of sound content categories, the method comprising:
receiving the audio signal;
providing the audio signal to a neural network that has been trained using known sound content corresponding to the plurality of sound content categories;
generating, by the neural network, a plurality of filters based on the audio signal, each of the filters corresponding to one of the plurality of sound content categories; and
separating the audio signal into the plurality of category specific audio signals by applying the plurality of filters to the audio signal.

2. The method of claim 1, further comprising identifying a plurality of features from the audio signal, wherein generating the plurality of filters is further based on the identified features.

3. The method of claim 2, wherein the features include information that is extracted from a time domain representation of the audio signal.

4. The method of claim 2, further comprising converting the audio signal from a time domain to a frequency domain, wherein the plurality of filters comprise frequency domain filters, and wherein the plurality of filters are applied to the frequency domain representation of the audio signal.

5. The method of claim 2, wherein the plurality of features include one or more of spectral magnitude information associated with the audio signal, spectral modulation information associated with the audio signal, phase differences between sound signals captured by a plurality of different microphones, magnitude differences between sound signals captured by the plurality of different microphones, and respective microphone energies associated with the plurality of different microphones with respect to the audio signal.

6. The method of claim 1, wherein the neural network has been trained by:
combining at least a first training signal of a first known sound content category and a second training signal of a second known sound content category into a combined training audio signal; and
training the neural network by feeding the combined training audio signal into the neural network and optimizing parameters of the neural network.

7. The method of claim 6, wherein optimizing parameters of the neural network includes iteratively updating the parameters and comparing an updated filter generated by the neural network to an optimal filter associated with one of the first and second training signals.

8. The method of claim 6, wherein the first and second training signals are clean signals having sound content corresponding to the first and second known sound content categories, respectively.

9. The method of claim 1, wherein each of the filters is a time-varying real-valued function of frequency.

10. The method of claim 9, wherein a value of the time-varying real-valued function for a corresponding frequency and a corresponding time frame represents a level of signal attenuation for the corresponding frequency at the corresponding time frame.

11. The method of claim 10, wherein the separating the audio signal into a plurality of category specific audio signals by applying the filters to the audio signal comprises:
separating the audio signal into a plurality of category-specific audio signals by multiplying the audio signal by the time-varying real-valued functions.

12. The method of claim 1, further comprising:
capturing, by one or more microphones, sounds of an environment into the audio signal, the sounds including sound corresponding to one or more of the plurality of sound content categories; and
outputting the category specific audio signals along with spatial information of sound sources that emit the sounds in the environment.

13. The method of claim 1, further comprising:
reproducing a virtual reality sound stage using the category specific audio signals.

14. The method of claim 1, further comprising:
enhancing a sound of a sound content category contained in the audio signal by attenuating sound levels of at least one of the category specific audio signals corresponding to other sound content categories of the plurality of sound content categories.

15. The method of claim 1, wherein the sound content categories include at least one of speech, music, ambient noise, animal sounds and background human speech.

16. A system for separating an audio signal into a plurality of category specific audio signals, each of the category specific audio signals containing sound content of a single corresponding sound content category among a plurality of sound content categories, comprising:
at least one microphone configured to capture an audio stream containing sounds emitted from sound sources of the plurality of sound content categories;
a feature extraction module configured to, for each time frame of the audio stream, extract features from the audio stream;
a neural network configured to, for each time frame of the audio stream, generate filters at the each time frame using the features as inputs, each of the filters corresponding to one of the plurality of sound content categories; and
a processor configured to apply the filters to the audio stream at the each time frame to separate the audio signal into the plurality of category specific audio steams.

17. The system of claim 16, wherein the processor is further configured to:
convert the audio stream from a time domain to a frequency domain;
apply the filters to the frequency domain representation of the audio stream; and
convert the plurality of category specific audio steams from the frequency domain to the time domain.

18. The system of claim 16, wherein the neural network is trained using known sound content corresponding to the plurality of sound content categories.

19. A method of audio signal enhancement, comprising:
receiving an audio signal;
generating a plurality of filters based on the audio signal, each of the filters corresponding to one of a plurality of sound content categories, the sound content categories including a target sound content category and one or more ambient sound content categories; and
separating the audio signal into a plurality of category specific audio signals by applying the filters to the audio signal, the category specific audio signals including a target audio signal of the target sound content category and one or more ambient audio signals of the ambient sound content categories; and
enhancing the target audio signal by attenuating the one or more ambient audio signals.

20. The method of claim 19, further comprising:
combining the target audio signal and attenuated instances of the one or more ambient audio signals into an enhanced audio signal.
